(19) United States
(12) Patent Application Publication
(10) Pub. No.: US 2026/0097519 A1
(43) Pub. Date: Apr. 9, 2026

(54) ROBOTIC KITCHEN SYSTEM WITH GREASE-COMPENSATING MARKERS TO IDENTIFY AND LOCATE OBJECTS IN THE KITCHEN WORKSPACE

(71) Applicant: Miso Robotics, Inc., Pasadena, CA (US)

(72) Inventors: Bachir Kharraja, Irvine, CA (US); Zachary Zweig Vinegar, Pasadena, CA (US); Hendry Joe, Irvine, CA (US); John Brugman, Pasadena, CA (US); Georgios Chantzialexiou, Pasadena, CA (US)

(21) Appl. No.: 19/344,221

(22) Filed: Sep. 29, 2025

Related U.S. Application Data
(60) Provisional application No. 63/703,937, filed on Oct. 5, 2024.

(51) Int. Cl. B25J 11/00; B25J 15/00; B25J 19/02

(52) U.S. Cl. CPC B25J 11/0045; B25J 15/0019; B25J 19/023

(57) ABSTRACT

A robotic kitchen assistant for preparing food includes a robotic arm, a camera assembly, a retro-reflective marker, and a computer programmed and operable to identify and locate the marker and object on which it is arranged based on image data arising from the camera assembly. A utensil adapter assembly can include a marker mount, and a 3D target for the robotic arm to grip. The robotic arm can be actuated to move to and capture the 3D target of the utensil adapter assembly. Related methods are also described.

### CROSS-REFERENCE TO RELATED APPLICATIONS

This claims priority to application no. 63/703,937, filed Oct. 5, 2024, and entitled “ROBOTIC KITCHEN SYSTEM WITH GREASE-COMPENSATING MARKERS TO IDENTIFY AND LOCATE OBJECTS IN THE KITCHEN WORKSPACE” incorporated herein by reference in its entirety for all purposes.

### BACKGROUND OF THE INVENTION

### 1. Field of the Invention

This invention relates to kitchen appliances and more particularly to robotic kitchen apparatuses for operation with a fryer in a restaurant environment.

### 2. Description of the Related Art

There are a number of challenges associated with robotically cooking food in a restaurant environment.

To cook autonomously, the robotic system needs to be able to locate the objects in its environment and track them after they have been moved. For example, if the robotic system is cooking a basket of raw food in a first fryer slot, and the user moves the basket to another second fryer slot, the system needs to know the updated state of the system and react accordingly.

One technique to detect and identify the objects is to add a fiducial marker with a unique identifier to each object. For example, with reference to FIG. 1, an ArUco marker 10 is shown and includes a unique binary pattern inside a square shape.

However, in a kitchen environment, and with reference to FIG. 2, oil and grease tends to collect on the marker's surfaces causing glare due to the external light arising from the hood and kitchen lights reflecting off the surface of the oil. This glare prevents the camera from reading the marker. This presents a big problem in autonomous kitchen systems.

Accordingly, a robotic kitchen assistant that overcomes the above-mentioned challenges is desirable.

### SUMMARY OF THE INVENTION

In an embodiment of the invention, a robotic kitchen system for carrying out a food preparation step within a robotic workspace comprises: a robotic arm; a camera assembly for obtaining image data of the robotic workspace; a utensil adapter assembly removably mounted to a utensil comprising a computer vision (CV) marker mount; at least one retro-reflective marker arranged on the CV marker mount; a computer programmed and operable to identify and compute the location of the utensil based on the image data of the at least one retro-reflective marker; and a robotic arm adapter having a proximal end coupled to the robotic arm and a distal portion adapted to releasably engage the utensil adapter assembly.

In embodiments, the robotic arm adapter comprises opposing movable gripping members having a first open configuration when the gripping members are separated, and a second closed configuration when the gripping members are urged towards one another.

In embodiments, the opposing gripping members define a capture region sized to engage a target feature of the utensil adapter assembly when the gripping members are in the second closed configuration.

In embodiments, the utensil is a fryer basket, and the utensil adapter assembly is secured to a handle portion of the fryer basket.

In embodiments, the target feature of the utensil adapter assembly comprises a three-dimensional shape.

In embodiments, the target feature is selected from the group consisting of a diamond, sphere, hourglass, and bulb.

In embodiments, the computer is further operable to instruct the robotic arm and gripper assembly to: move the gripper assembly to the target feature; grasp the target feature; move the utensil; and release the utensil.

In embodiments, the camera assembly comprises at least one Infra-Red (IR) emitter, and optionally more than five (5) IR emitters.

In embodiments, the wavelength of the IR emitter ranges from 900 to 1000 nm.

In embodiments, the camera assembly further comprises a bandpass filter selected to filter light to the lens. In embodiments, the bandpass filter limits the wavelength of light to reach the lens to 900 to 950 nm.

In embodiments, the camera exposure settings are controlled to reduce the light received and optionally, the shutter speed is reduced 300-600 μs below the auto exposure settings, or to about 7000-8000 μs when normal auto exposure is about 8200 μs.

In embodiments, the marker is a fiducial marker or an ArUco or ArUco-like marker.

In embodiments, the at least one marker comprises a plurality of markers, at least one of which is at a different angle to the other.

In embodiments, the mount is spaced above and over the basket.

In embodiments, a portion of the mount is parallel to the floor of the basket.

In embodiments, a robotic kitchen system for carrying out a food preparation step within a robotic workspace comprises: at least one retro-reflective marker arranged on an object in the kitchen workspace; a camera assembly comprising a light emitter and aimed at a scene containing the at least one retro-reflective marker, said camera assembly generating image data of the scene including the at least one retro-reflective marker; and a computer programmed and operable to identify and locate the at least one retro-reflective marker based on the image data.

In embodiments, the emitter is an IR emitter.

In embodiments, the object is a fryer basket.

In embodiments, a method for carrying out a food preparation within a robotic kitchen workspace, the method comprising the steps of: installing a retro-reflective marker on an object in the robotic kitchen workspace; directing IR light from a light source at a scene containing the marker; receiving light reflected off the marker and the surroundings; generating image data of the scene including the marker; and detecting the identity and location of the marker based on the image data.

In embodiments, the method further comprises filtering the light by wavelength prior to the generating step.

In embodiments, the method further comprises reducing the amount of light by exposure settings prior to the generating step.

In embodiments, the installing comprises installing multiple markers, one of which is at a different angle to the other.

In embodiments, the retro-reflective marker comprises a composite graphical image comprising first elements having retro-reflective properties and second elements having non-retro reflective properties, and optionally, wherein the first elements are white, and the second elements are black.

The description, objects and advantages of embodiments of the present invention will become apparent from the detailed description to follow, together with the accompanying drawings.

### BRIEF DESCRIPTION OF THE DRAWINGS

FIG. 1 is an example of a fiducial marker;

FIG. 2 is an example of a marker array on a fry basket subject to glare;

FIG. 3A is a perspective view of a robotic kitchen assistant holding a fryer basket;

FIG. 3B is an enlarged perspective view of a portion of the robotic kitchen assistant holding the fryer basket;

FIG. 4A is a front perspective view of a fryer basket;

FIG. 4B is a rear perspective view of a fryer basket and a utensil adapter secured to the basket handle;

FIGS. 5A-5B are various perspective views of the utensil adapter shown in FIG. 4B with the fryer basket removed for clarity;

FIG. 6 is an enlarged perspective view of a fryer basket, a utensil adapter secured to the fryer basket, and a robotic arm adapter for engaging the utensil adapter;

FIG. 7 is an enlarged view of a portion of a robotic arm adapter engaging a target feature of a utensil adapter in accordance with one embodiment of the invention;

FIG. 8 is an upper perspective view of a robotic arm adapter in accordance with one embodiment of the invention;

FIG. 9 is an upper perspective view of a fry basket, target and marker in accordance with embodiments of the invention;

FIG. 10 is an illustration of a camera in accordance with embodiments of the invention;

FIG. 11 is an illustration of a camera and retro-reflective marker in an application in accordance with embodiments of the invention;

FIGS. 12A-12B are illustrations of raw image data of two fry basket retro-reflective markers reflecting IR light without and with light exposure adjustment, respectively, in accordance with embodiments of the invention;

FIG. 13 is plot showing visibility of retro-reflective and regular markers;

FIG. 14 is a marker template matching method according to embodiments of the invention;

FIG. 15 is a schematic diagram of marker tracking system according to embodiments of the invention;

FIGS. 16A-16D are top, front, right side, and left-side bottom perspective views, respectively, of a fryer station in accordance with an embodiment of the invention; and

FIG. 17 is an illustration of a shelf unit including two slots, in accordance with embodiments of the invention.

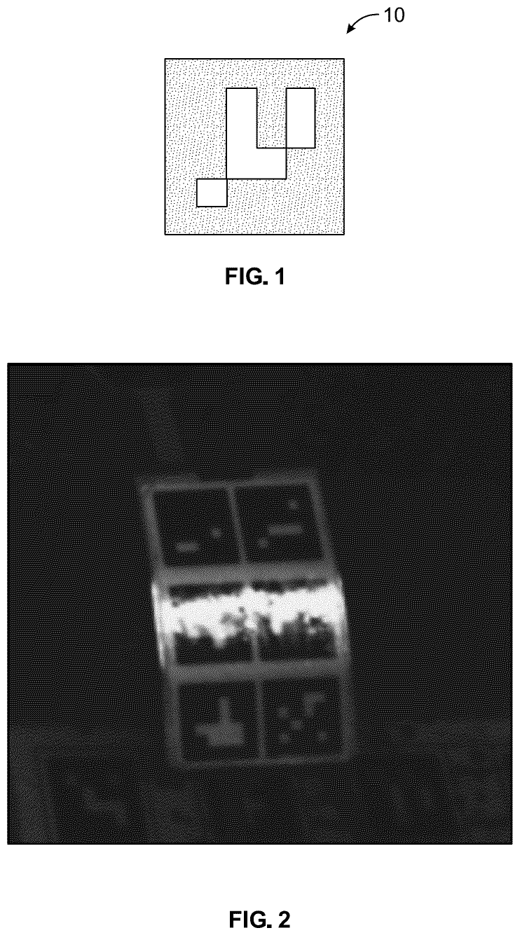

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Described herein is a robotic kitchen assistant for preparing food.

### Overview

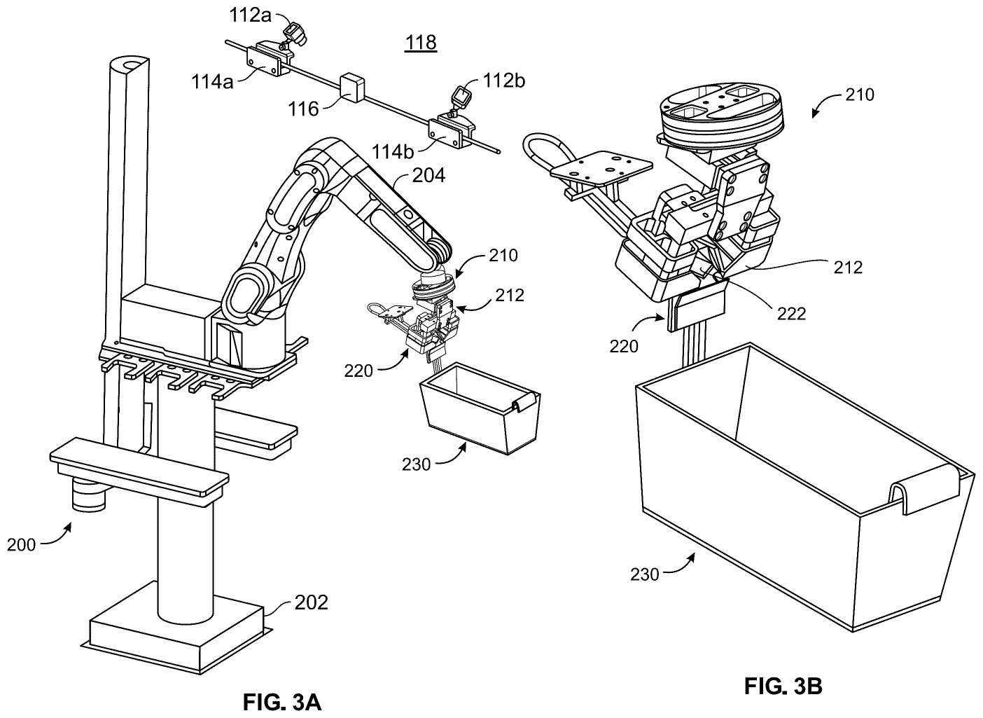

With reference to FIGS. 3A-3B, a robotic kitchen assistant 200 is shown in accordance with an embodiment of the invention. The robotic kitchen assistant 200 includes a base or housing 202, robotic arm 204, cameras 114a, 114b and a computing device 116. Optionally the cameras and computer can be mounted on hood 118.

In embodiments, the robotic kitchen assistant 200 includes a programmable processor, memory, cameras and sensors, displays, links, joints, actuators, power supply, and various user interface devices, to communicate, compute, and control movements of the robotic arm and end effectors including the gripping means described herein to operate with a fryer in a restaurant kitchen. In embodiments, and as described in the patent publications mentioned herein, the robotic kitchen assistant employs a trained neural network to locate and recognize food items and utensils to manipulate. Examples of robotic kitchen assistants and systems for preparing food are described in, e.g., international application no. PCT/US18/21066, filed Mar. 6, 2018, entitled “ROBOTIC KITCHEN ASSISTANT FOR PREPARING FOOD ITEMS IN A COMMERCIAL KITCHEN AND RELATED METHODS”, and international application no. PCT/US18/20948, filed Mar. 5, 2018, entitled “AUGMENTED REALITY-ENHANCED FOOD PREPARATION SYSTEM AND RELATED METHODS”, each of which is incorporated by reference in its entity for all purposes.

With reference again to FIGS. 3A-3B, the robotic kitchen assistant 200 is shown including a robotic arm adapter assembly 210 including a gripping feature 212, a utensil adapter assembly 220 comprising a target 222 for the gripping feature 212 to capture. The robotic adapter assembly and utensil adapter assembly enables large tolerances for grabbing kitchen equipment (e.g., fryer basket 230) with a custom grab point attached to the equipment while still maintaining a rigid grip after engaging the equipment.

Embodiments of the invention described herein overcome the challenge of the so-called tolerance stack-up in today's kitchen environments because it is difficult to control the shapes and tolerances of kitchen implements (baskets get bent), kitchen equipment is not manufactured to high tolerances, and vision and depth sensors are not perfectly accurate.

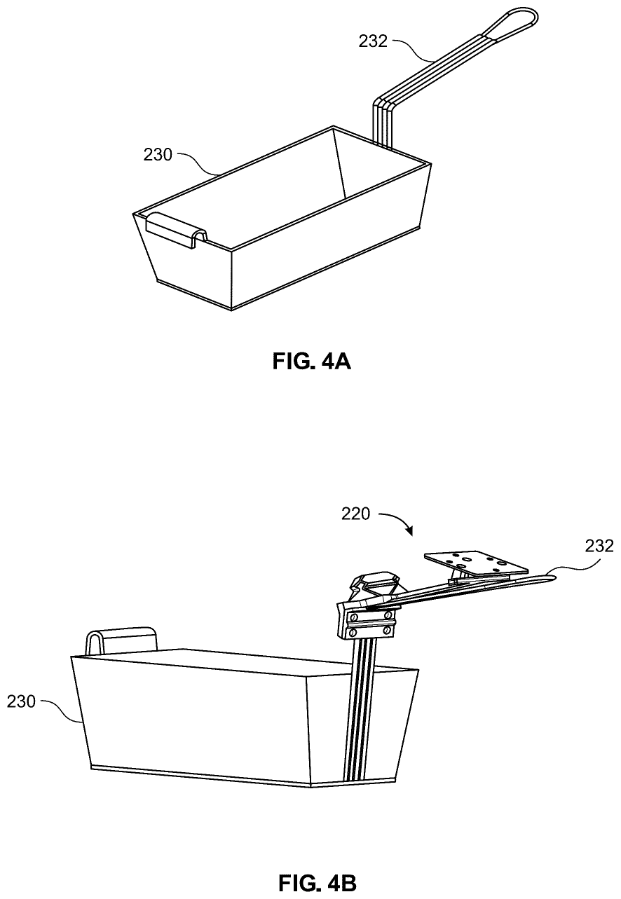

With reference to FIGS. 4A-4B, an enlarged view of a basket 230 is shown comprising a handle 232 to which the utensil adapter assembly 220 may be secured.

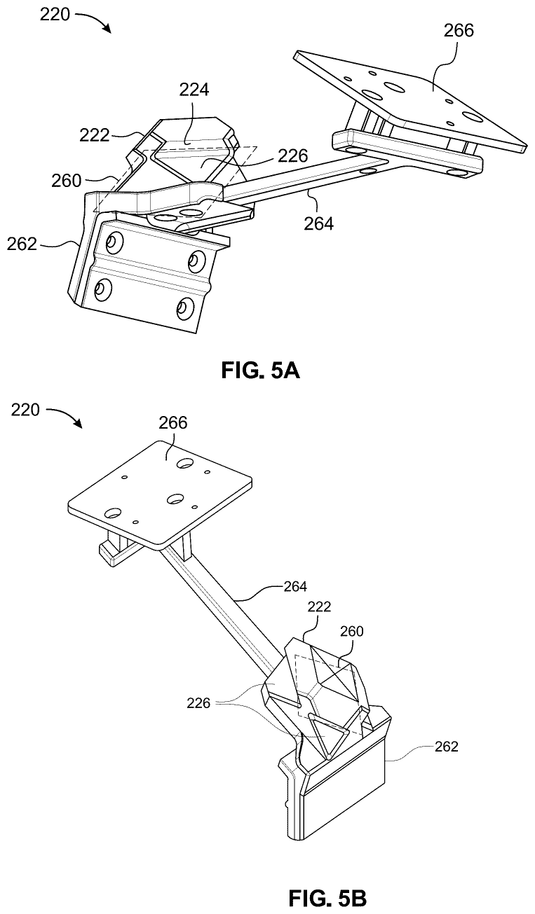

FIGS. 5A-5B show enlarged perspective views of the utensil adapter assembly 220 including a clamp 262 to engage the handle of the basket, a body 264, a target feature 222 to be captured by the robotic arm adapter assembly, and a computer vision (CV) marker mount 266 for the cameras to view for location information.

The target feature 222 shown in FIGS. 5A-5B has a diamond-shape and eight bearing surfaces 224, 226.

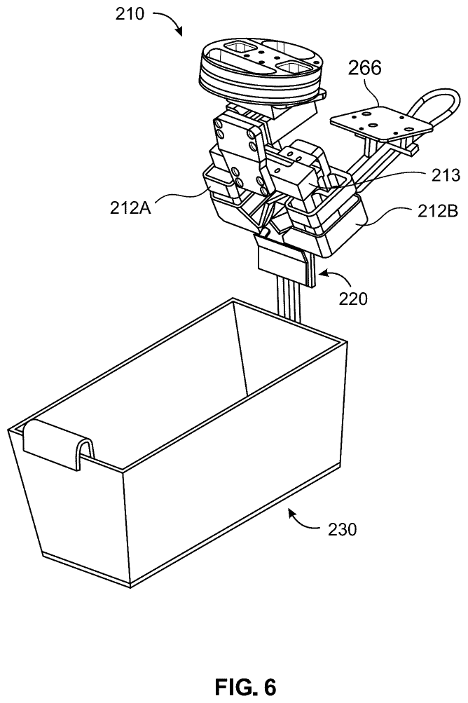

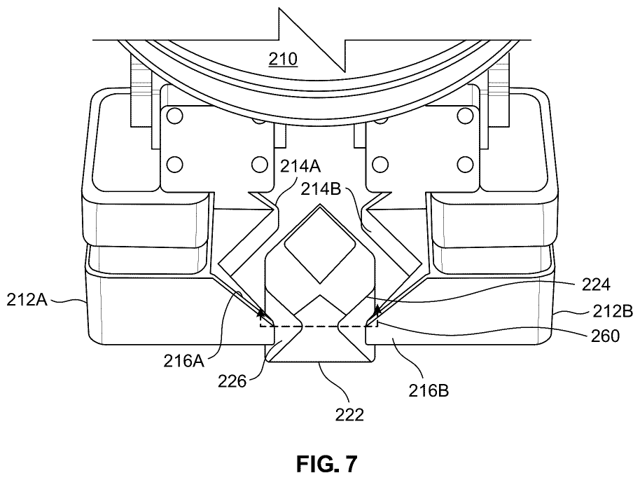

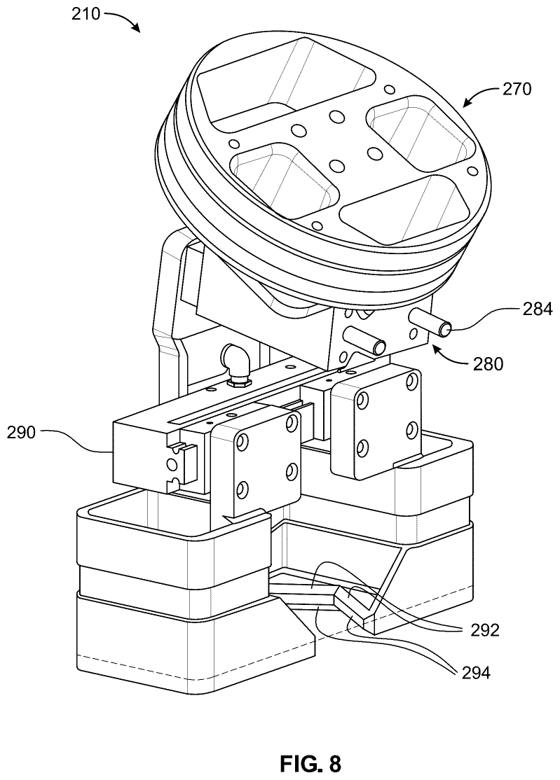

With reference to FIGS. 6-7, parallel actuating gripper 212A, 212B and two “fingers” (or teeth) 214A, 214B, 216A, 216B serve to initially contact the four lower bearing surfaces 226 on the target 222 and then slide up until contact is made with the four upper bearing surfaces 224. The four upper bearing surfaces 224 and the top of the diamond 222 are made as small as possible so as to not restrict horizontal grabbing tolerances while the robot arm approaches from above. By gripping below the clamp plane 260, symmetric tolerances can be attained in both horizontal and vertical dimensions. In a sense, the angled bearing surfaces or faces guide the teeth into the desired recess, slot, detent, or clamping plane 260.

The parallel actuating gripper members 212A, 212B shown in FIG. 6 are driven by an actuator 213, which in embodiments, is pneumatic-based.

A process to grab a handle of a basket or another food preparation item in accordance with an embodiment of the invention comprises the following steps:
1. Robotic kitchen assistant obtains estimate of basket handle in 6 DOF using sensors and knowledge of prior state. For example, as discussed herein, a computer vision marker on mount 266 can be used to detect, identify and locate the fry basket.
2. Robotic kitchen assistant aims to capture the target slightly lower than the clamp plane to account for additional error.
3. Robotic kitchen assistant grabs handle. In embodiments, the gripper mechanism is designed to self-center and positive lock in the same location given ˜0.75″×0.75″×0.5″ tolerances and +/−5 deg in orientations.
4. In embodiments, force feedback is used to validate that the gripper has solid grip on basket and confirm pickup and that the basket is not stuck on anything. In embodiments, the robotic kitchen assistant uses sensors to measure or monitor applicable forces. In embodiments, the robotic kitchen assistant uses sensors to measure motion of the basket relative to the gripper to improve the grabbing motion.

### Agitator

In embodiments, the robotic kitchen assistant is operable to de-clump fried food so that the fried food may be cooked uniformly before final serving and in particular embodiments, an actuator assembly is operable to cause the fryer basket to shake and de-clump the fried food.

FIG. 8 shows a robotic arm adapter assembly 210 including a robotic arm interface 270, an agitator assembly 280, and a gripper portion 212. The agitator assembly 280 shown in this embodiment includes a pneumatic actuator, two linear bearings, and two guides 284. The actuator is pulsed causing the basket to shake. Although a pneumatic actuator is described, the invention is not so limited and other types of actuators may be used such as, e.g., a flat DC motor.

In embodiments, and with reference to the agitator shown in FIG. 8, a method to prevent food from sticking together in a basket in a fryer comprises the following steps:
1. Robotic kitchen assistant identifies and localizes the basket with respect to the fryer. For example, as discussed herein, a computer vision marker on mount 266 can be used to detect, identify and locate the fry basket.
2. Robotic kitchen assistant grabs basket handle with gripper 212. The action for the gripper arises from a first actuator in the gripper assembly 212.
3. Robotic kitchen assistant uses a second pneumatic or actuator 280 to impart momentum into the food particles through the basket.
4. Whether actuator 280 reaches end of stroke or basket hits back of fryer, the rapid acceleration/deceleration helps agitate the food in the basket to prevent it from clumping together.
5. In embodiments, the robotic kitchen assistant uses sensors to evaluate the effectiveness of the agitation, e.g., whether food items were broken up. This could be carried out in various ways such as, for example, using a trained Neural Network in a similar fashion to the way the food type is classified, mentioned above.

The agitator 280 provides sufficient force to move food in the basket. However, in embodiments, dampening effects between gripper and robot ensure no large forces are imparted to the robot that could damage its mechanical components. Dampening can be accomplished in a number of ways such as, for example, by adding a dampening material in between the gripper and the arm. The dampening material acts as a shock absorber or cushion. The forces can also be adjusted by balancing deceleration to allow the food to be shaken but not enough to damage the robot. In embodiments using pneumatic actuators, the forces are adjusted by tuning the air pressure.

In another embodiment, one actuator is employed to both grab the handle or kitchen utensil, and to impart momentum into the food particles through the basket.

### Camera Assembly

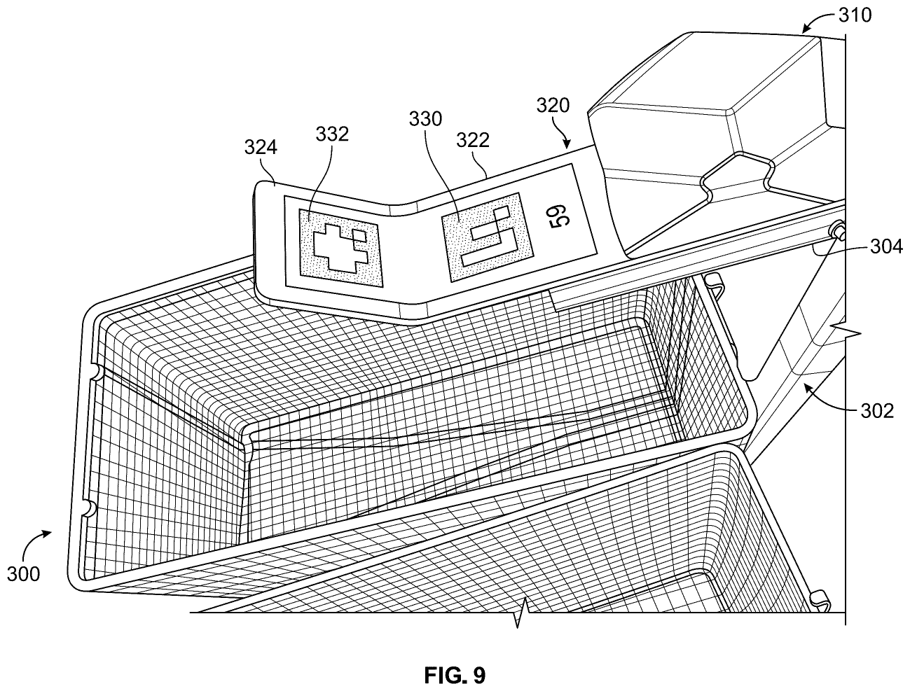

FIG. 9 is an upper perspective view of a fry basket 300, handle 302, target 310 and CV mount 320 in accordance with embodiments of the invention.

Unlike handle 232 of fry basket 230 described above, handle 302 includes only a forward extension 304 upon which target 310 and CV mount 320 are mounted. Extension 304 is arranged above and over the basket

CV marker mount 320 is shown including two discrete regions 322, 324 arranged at an angle to one another. In particular, region 324 is arranged at an acute angle to region 322. In embodiments, the acute angle ranges from 5 to 45 degrees, and more preferably from 5 to 25 degrees. Each of the regions comprises a unique fiducial marker 330, 332 which is detectable by the cameras, discussed herein.

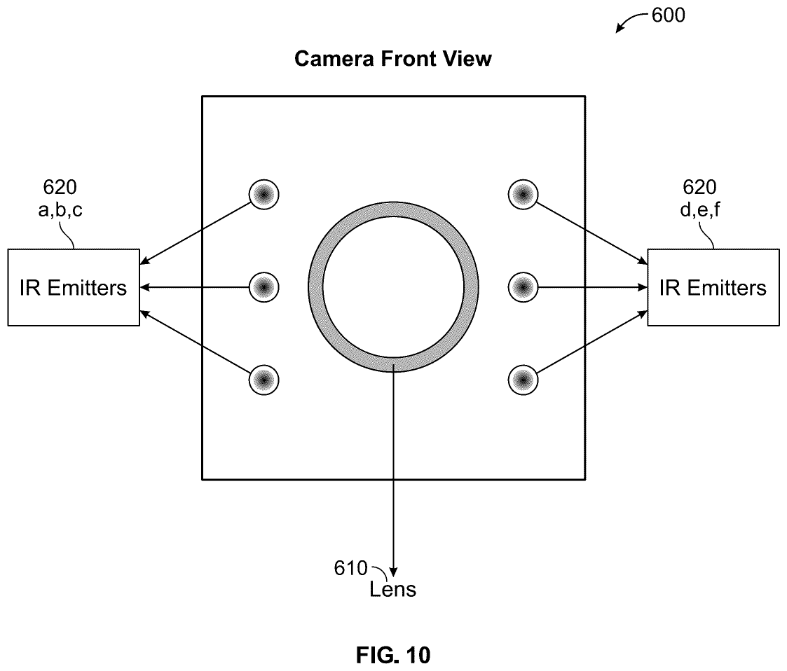

FIG. 10 is an illustration of a camera 600 in accordance with embodiments of the invention. Camera includes a lens 610 and at least one infrared emitter 620. In embodiments, the lens ranges from 10-20 mm in diameter, and in some embodiments, ranges from 13-15 mm in diameter.

In the embodiment shown in FIG. 10, the camera assembly 600 includes a plurality of emitters 620 a, b, c, d, e, f. The emitters are shown symmetrically arranged in two parallel lines-one line on the left side and one line on the right side of the lens. As described herein, in embodiments, the emitters are as close as possible to the lens for the purpose of enhancing the retro-reflective properties of the marker. In embodiments, the emitters are located (center to center) 10-20 mm from the lens.

In another embodiment, the emitters encircle the lens. The number of emitters may vary and range from 1-10, and preferably ranges from 3-6. Optionally, the emitters can be arranged to send light at different angles from one another.

In embodiments, the emitters deliver light having a wavelength in the near IR range typically between 750 and 1400 nm, and preferably between 900 and 1000 nm, and most preferably between 900 and 950 nm.

Additionally, in embodiments, the lens 610 is equipped with a near IR wavelength bandpass filter in the range from 900 to 950 or about 940 nm. With the combination of 940 nm IR emitter and bandpass filter, the system has better control of the light source. The inventors have found that the fryer hood light and kitchen ceiling light do not emit a significant amount of 940 nm light. Any other 940 nm light source tends to be overpowered by the camera's IR emitter. The IR emitter makes the marker more visible, as discussed further herein.

An example of a suitable camera is model Arducam B0490, manufactured by Arducam (China). The IR emitter(s) can be integrated into the camera manufactured by the same company.

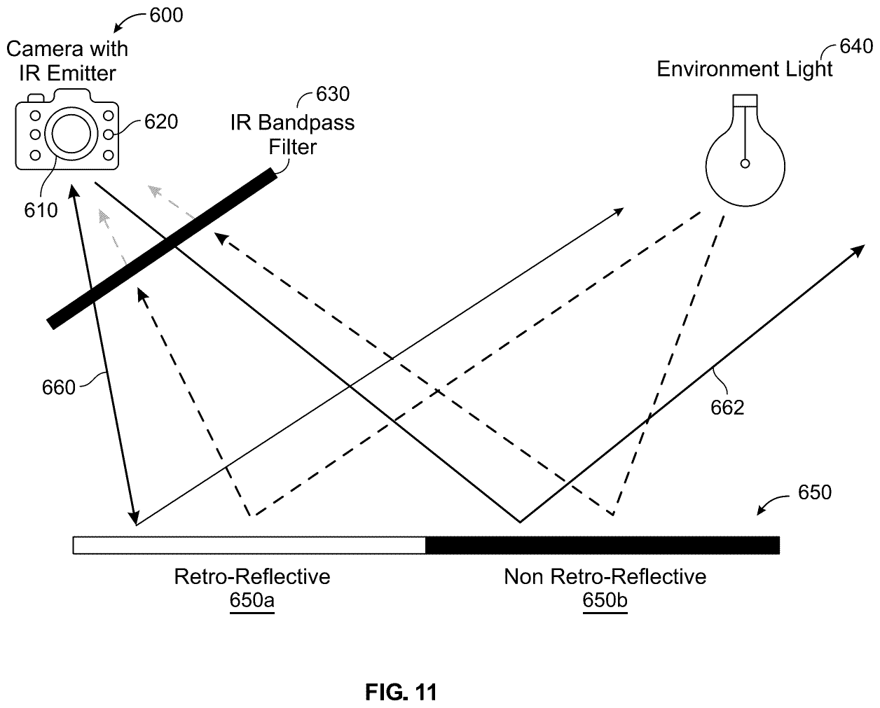

FIG. 11 is an illustration of a camera 600 and retro-reflective marker 650 in accordance with embodiments of the invention.

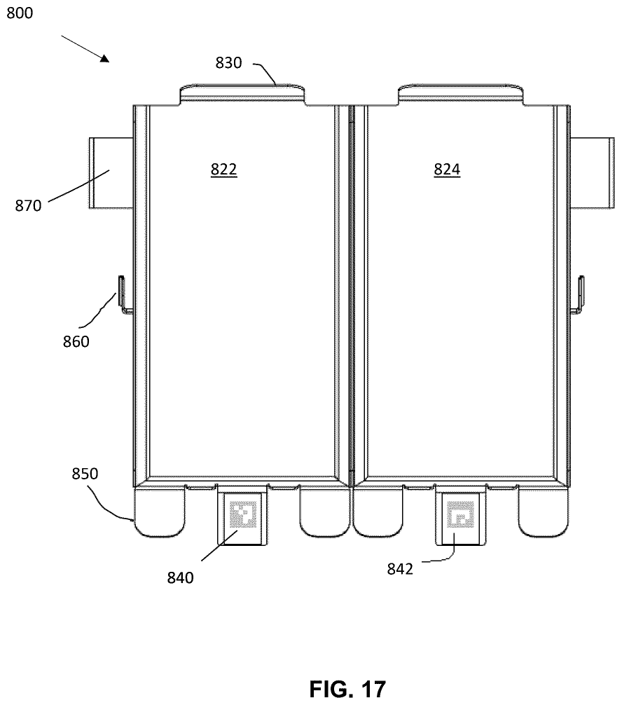

Marker 650 can be a fiducial CV marker arranged on a marker mount of the fry basket or another object (e.g., appliance, utensil, etc.). In embodiments, and with reference to the shelf unit 800 shown in FIG. 17, a marker 840 is arranged on marker stage for each slot 822, 824. An example of a fiducial marker is an ArUco or ArUco-like marker. In preferred embodiments, the marker is made of retro-reflective materials. Retro-reflective materials reflect light 660 back to the light source. Retro-reflective materials can be implemented in the form of thin tapes and are commercially available for vehicles and outdoor signs. Such materials can comprise microspheres or prisms that reflect the light back to the source.

In embodiments, a retro-reflective marker includes a white part made out of retro-reflective materials and the black part made out of non-retro-reflective materials such that the white region of the marker tends to be as bright as possible and the black region is as dark as possible. The configuration of the white and black parts can be chosen and formed similar to that of a conventional CV marker except for the materials used for the white and black regions. In embodiments, the marker is a composite graphical image having both retro-reflective elements and non-retroreflective elements.

FIG. 11 also shows an IR bandpass filter 630. As described herein, the filter limits the light to elements to a specific IR range, and in embodiments, the range is from 930 to 950 nm. Environment light 640 is filtered out.

By combining the IR emitters 620 around the camera lens 610 with the retro-reflective markers, wherein the white part 650a of the markers reflects most of the light back 660 directly to the camera 600, while the black part 650b absorbs or scatters 662 the light. Even when there is oil on the markers, the white regions 540(a) of the markers will still be brighter than the black regions 540(b).

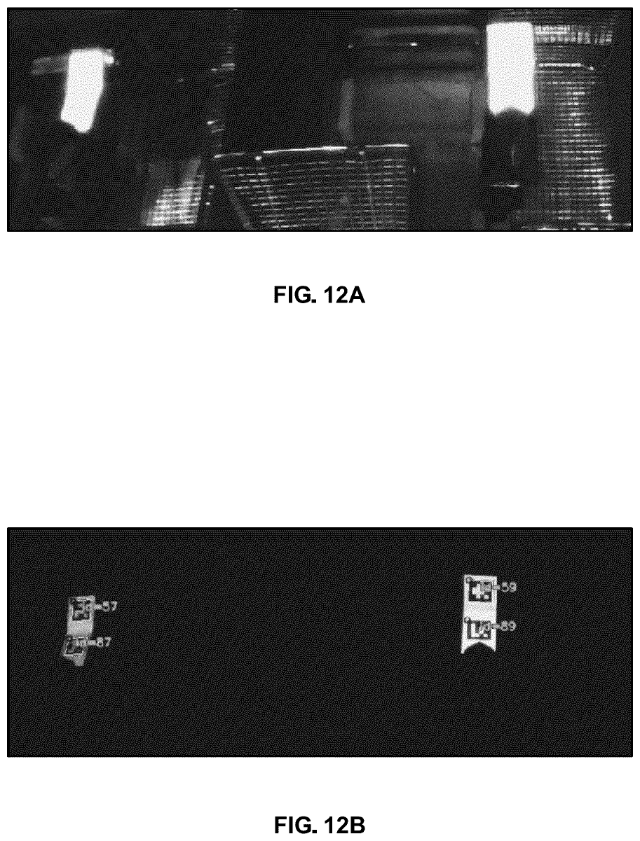

FIG. 12A is an image corresponding to the camera setup described in FIG. 11 of two fry baskets, each having a retro-reflective ArUco-type marker. The image shows that the two retro-reflective markers are much brighter compared to the surrounding environment. The main light source for the two markers is the IR emitters which reflect the IR light directly back to the camera lens. IR light to hit the surrounding environment scatters. The surroundings appear dark because there is no other significant 940nm light source in the environment.

FIG. 12B is an image of the same scene shown in FIG. 12A, except the lens exposure is decreased. By adjusting the camera exposure, the markers are made resistant to glare due to oil since any kind of glare will be overpowered by the bright portion of the markers corresponding to reference numeral 650a of FIG. 11. The retro-reflective markers and its encoded information are now clearly visible.

The exposure settings may vary. In embodiments, the camera exposure settings are controlled to reduce the light received as described above.

In embodiments of the invention, an advantage is that even if the marker ID cannot be read due to damage, the marker's presence can still be detected by the shape seen through the sensor (e.g., camera, IR, etc.). If the method detects the outer shape of the marker, but not the fine grained ArUco pattern within, then the method assumes the marker is there but is unsure of the ID. This blocks any issues from occurring in that slot, and alerts the user that this marker is no longer visible.

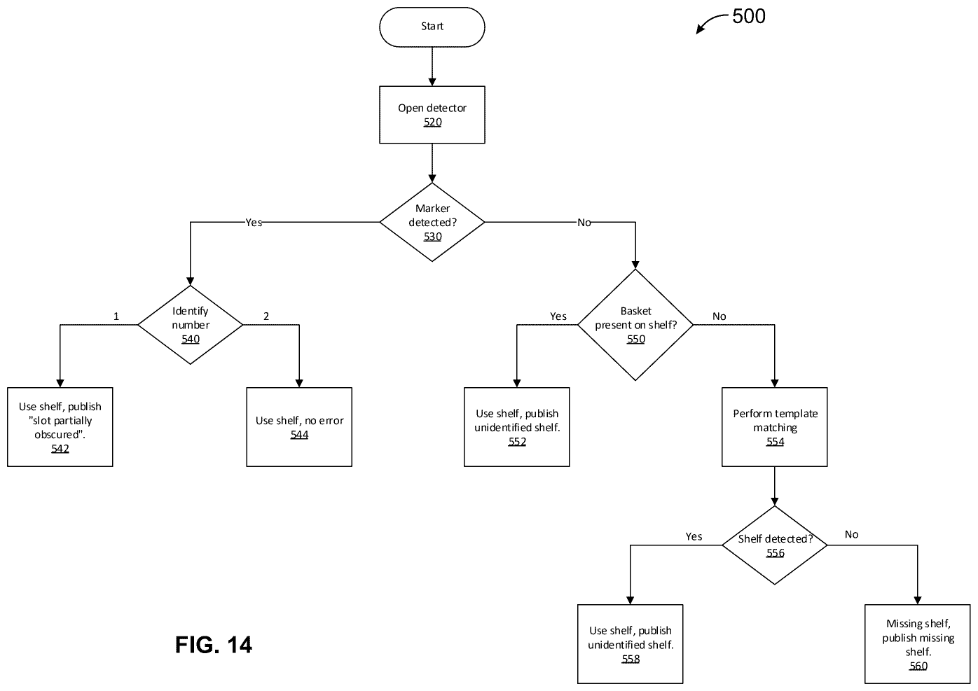

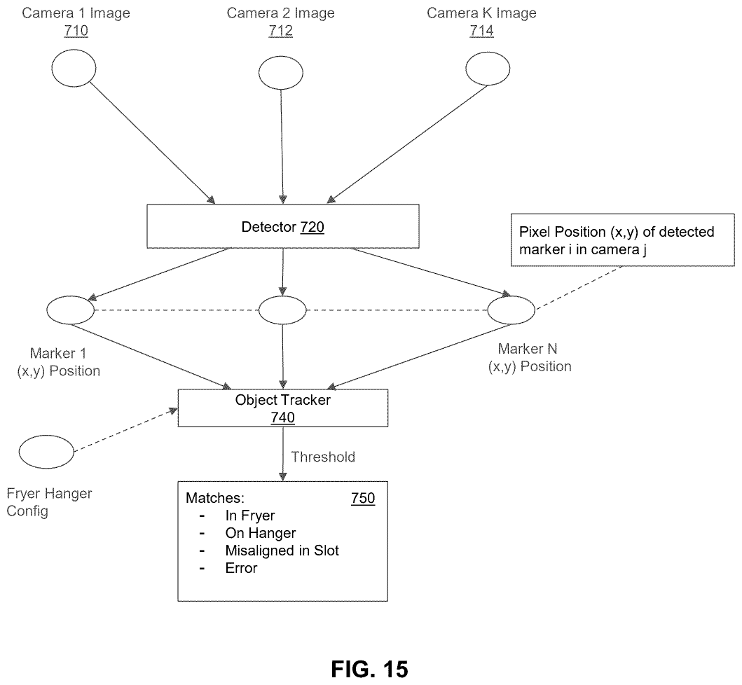

FIG. 14 shows a multi-phase method 500 to assist with locating an object in the robotic kitchen workspace, according to embodiments of the invention. In describing various steps of the method 500, and to facilitate understanding, reference is also made to FIGS. 15-17. Also, although specific reference is made to locating a shelf (e.g., shelf 800 shown in FIG. 17) in describing the method 500, the invention is applicable to locating other objects in the robotic workspace including, without limitation, fry baskets, utensils, fryers, etc.) according to other embodiments of the invention.

### Phase I

Step 520 states to open the detector 720. This step calls and opens the detector. An example of a detector for determining ID and location is binary square marker detection algorithm. In embodiments, the detector searches for square-shaped contours using an edge detection scheme, and finds the contour. It filters out non-quadrilateral shapes. It warps the candidate square to a canonical square using a transform, so the internal binary pattern can be analyzed consistently. It then divides the warped image into a grid, and compares the extracted binary pattern against a predefined dictionary of valid marker IDs to identify a match. An example of a binary square marker detector is the ArUco detection algorithm (via OpenCV).

State 530 states marker detected. This step queries whether a marker is detected by applying the above-described detector. Additionally, in embodiments, to suppress false positives caused by reflections, lighting artifacts, or motion noise, a consensus filtering algorithm is applied. A marker is accepted only if at least 10 of the captured frames (out of 30-40) consistently report the same marker ID and position. If this consensus is not achieved, the marker is rejected.

### Mapping

Confirmed markers are then mapped to predefined regions of the fryer, which have been previously segmented into logical planes (e.g., shelves, fryer wells, etc.). In embodiments, the object tracker 740 matches the location of the marker to a category based on a spatial threshold between a predefined region volume and the detected pixel location for the marker. Examples of categories include, without limitation, in fryer, on shelf, misaligned in slot, and error.

Markers are rejected that are not associated with any shelf or basket.

### Filtering

In embodiments, temporal filtering is performed in place to use only the last X found observations within the last t seconds to reduce light variance. In embodiments, X ranges from 10-20 or about 10-15; and t can range from 1-5, and sometimes about 1-2 seconds.

If the marker is detected according to step 530, the method proceeds to step 540 which identifies the number of markers detected.

If only 1 marker is detected, the method proceeds to step 542 in which the shelf is considered to be successfully detected by inferring the existence from the other marker of the shelf unit 800. The method publishes “slot partially obscured” to inform the engineering, support team and the user that 1 out of the 2 markers wasn't detected successfully. By “slot partially obscured, it is meant that only one of the two expected markers 840, 842 for the shelf unit 800 has been detected. The shelf is considered valid, but marker visibility is impaired.

If both markers are detected, the method proceeds to step 542 in which the shelf is considered to be successfully detected. No error is reported since both markers have been detected.

### Phase II

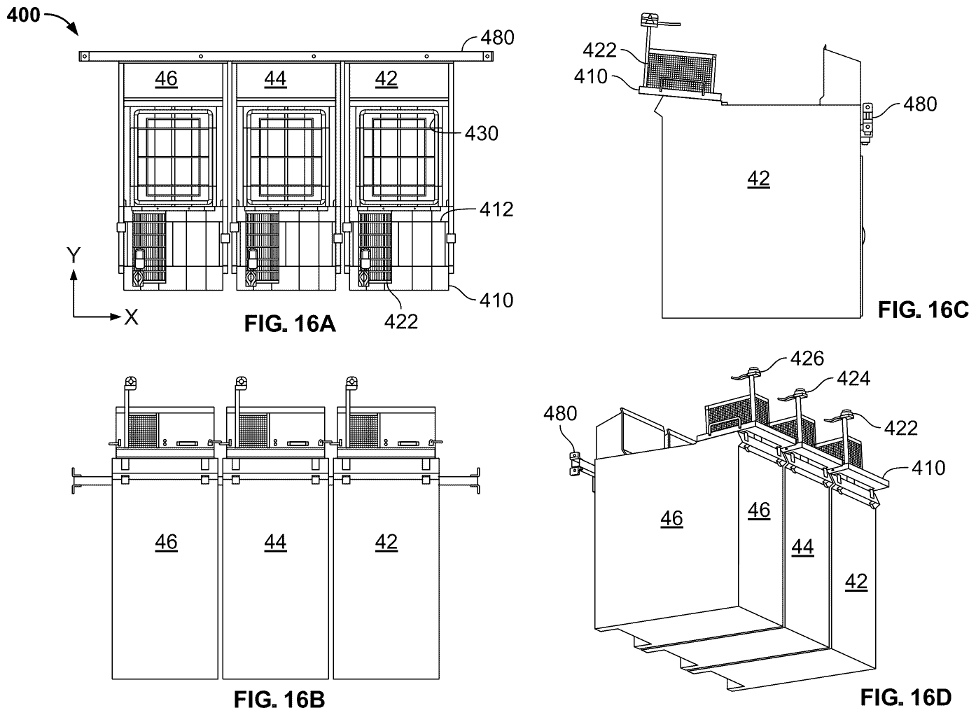

If the marker is not detected according to step 530, the method proceeds to step 550 which identifies whether a basket is present on the shelf. In embodiments, a basket (e.g., basket 422 shown in FIGS. 16A-16D) is detected using the same logic as described herein for detecting the shelf unit (e.g., by applying the detector algorithm described in connection with steps 530 to detect the marker ID and location of the basket marker). However, other or additional detector logic can be applied to detect for the basket presence and the invention is only intended to be limited as recited in any appended claims.

If a basket is detected on the shelf, the method proceeds to step 552 which states that the shelf has been successfully detected, and publishes unidentified shelf. By “unidentified shelf” it is meant a shelf unit 800 is detected by means other than complete marker identification (e.g., basket presence or template matching), but the shelf cannot be uniquely identified.

### Phase III

If a basket is not detected on the shelf, the method proceeds to step 554 which states perform template matching for determining whether a shelf can be detected 556. In embodiments, a template matching algorithm is applied such as the cv2.matchTemplate from OpenCV library to identify white rectangular regions in the region or object of interest such as the markers arranged on the shelf as described herein. In embodiments, the template matching algorithm scrutinizes the image for a square shape.

In embodiments, the algorithm is not applied to the entire image but instead operates only within a defined region corresponding to the object of interest (e.g., the shelf). For each object under detection, template matching is constrained to this specific region, which may include a padding margin around the target area to account for positional variation. Only when the template match occurs within this designated region will the algorithm accept the match. This ensures that the detected template corresponds to the intended object, despite the fact that templates for different object types may share the same appearance.

If a shelf is detected based on the finding a marker, the method proceeds to step 558 which states to use shelf, and publish unidentified shelf as described above in connection with steps 552 because although a marker was detected, it is not identified by marker ID.

If a shelf is not detected, the method proceeds to step 560 which states missing shelf, and publishes missing shelf. By “missing shelf” it is meant that no shelf unit has been detected by ArUco markers, basket presence, or template matching.

FIG. 15 is a schematic diagram of a system for tracking markers (namely, marker 1, marker 2, to marker N) to regions of interest 750 using cameras 710, 712, 714, according to embodiments of the invention.

As shown, a 2D detector 720 as described above is applied to detect and identify the marker, where for each marker i, the x, y pixel position is obtained for each camera 710, 712, 714.

Object tracker 740 is applied to locate each marker in the predetermined region of interests 750. Regions of Interest (ROI) are implemented to help determine the alignment of the basket/shelf/fryer markers. If the detected marker is within the predetermined ROI area, then the operation status is deemed okay, and proceeds according to schedule. If the marker is detected outside the ROI zone, the system will give an error as described above and not allow the user to use that slot/basket/fryer. The inventors have found this to be important to prevent issues with baskets/shelves/fryers not being in the proper location, leading to dangerous errors or damage to equipment inside the robotic workspace.

FIGS. 16A-16D show different isolated views of a fryer and location basket implementation 400. Each of the fryers 42, 44, 46 includes a fryer localization fixture 412 in the form of a cage or frame. The open frame 412 supports the fry basket 422 in the XY plane and outside of the oil footprint of the oil reservoir 430. As shown, each fry basket localization fixture includes two defined regions (or slots) to accommodate two fry baskets. The implementation shown in FIGS. 16A-16D can accommodate draining or holding up to 6 fry baskets while frying or waiting. Such a configuration offers flexibility during scheduling and increases throughput as multiple fryer baskets can be draining and cooking simultaneously. In contrast, holding one fry basket over the oil limits access to the oil reservoir, reducing throughput.

The implementation shown in FIGS. 16A-16D also shows shelves 410 under each of the frames. The shelves 410 are arranged at a slight angle or tilt towards the oil in the fryers. Oil drippings that fall onto the shelves are directed back to the oil reservoir in the fryer. Optionally, the frame and shelf may be one integrated unit or separate components detachably arranged together.

In embodiments, the robotic arm and computer system are programmed and operable to place the shelves and frames during cooking operations or as otherwise desired. For example, if a fryer needs a new shelf or frame, the robotic arm can move it to the auto-drawer assembly to be transferred from the robotic enclosure. A new shelf and frame may be delivered into the robotic enclosure via a drawer assembly which is operable to transport items from outside the robotic workspace to inside the workspace. In embodiments, swapping or interchanging shelves 410 and frames 412 can thus be performed automatically and without violating the robotic enclosure.

FIG. 17 shows a shelf unit 800, according to embodiments of the invention. Shelf unit 800 has two slots 822, 824 separated by a wall for supporting fry baskets. Each slot has a marker stage and marker 840, 842 as described above. Shelf unit 800 is also shown with hard stops 830 and gently sloping guides 850, which along with the center wall, serve to locate the baskets in the slots. Downward extending arms 860, 870 are arranged to secure the shelf unit on the appliance as shown in FIGS. 16A-16D.

### Example

A study was performed to compare a robotic kitchen system using retro-reflective markers and non-retroreflective markers subject to grease.

### Setup

Six conventional (non-IR reflective) ArUco markers and six IR reflective (or retro-reflective) ArUco-type markers as described above in accordance with embodiments of the invention were provided. For each test, all six markers were mounted in the same plane to a marker plate, and the marker plate was mounted to a motor operable to rotate the marker plate in 5 degree increments from 0 to 90 degrees.

Grease was manually applied to the markers to simulate the marker in the kitchen environment.

A camera and IR emitter assembly, as described above in connection with FIG. 10, was arranged 80 cm from the marker plate.

### Testing—Non-Reflective Marker

For the testing of the non-reflective markers, the external (non-IR) lighting in the room was turned on. The face of the marker plate was initially arranged parallel to the camera view or 0° (so the camera could not see the face of the markers). The marker plate was rotated in 5° increments from 0 to 90°. At each increment, 100 photos were taken. The steps of rotation and generating photos were repeated until the marker plate faced the camera view at 90°.

### Testing—IR-Reflective Marker

For the testing of the IR-reflective or retro-reflective markers, the external (non-IR) lighting in the room was turned off and the internal IR lights (i.e., the 6 emitter IR LEDs as described above) were turned on. The photo generation and camera rotation steps were performed as described above for the non-reflective marker testing.

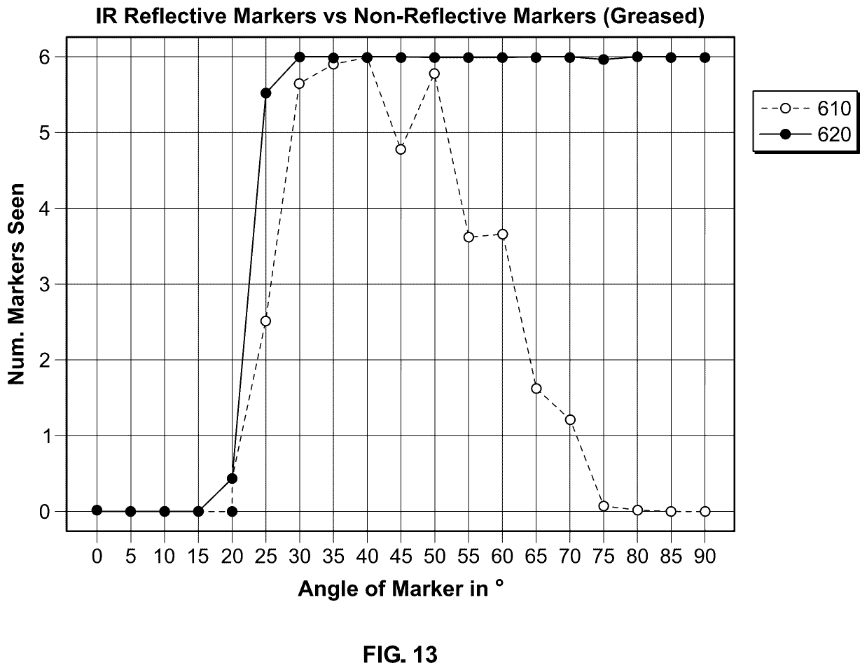

All images were recorded and evaluated for detecting the marker tags. The results are presented in the plot shown in FIG. 13, in which each point represents 100 photos. FIG. 13 shows that for the non-reflective markers 610, the number of tags detected falls significantly at around 45°, while for the IR reflective markers 620, the number of tags detected stays consistent (all 6 tabs are detected) until 90° at which angle the light reflects directly back to the camera creating their own glare.

This data is evidence that the new retro-reflective marker system described herein outperforms the conventional non-IR marker systems when subjected to grease and varying angles as commonly found in the restaurant kitchen environment. Without intending to be bound to theory, the inventors opine the improvement in the new system arises by a combination of reducing glare arising from the ambient light and increasing visibility of the features in the marker tag reflecting the IR light.

### Alternative Embodiments

Throughout the foregoing description, and for the purposes of explanation, numerous specific details are set forth in order to provide a thorough understanding of the described techniques. It will be apparent, however, to one skilled in the art that these techniques can be practiced without some of these specific details. Although various embodiments that incorporate these teachings have been shown and described in detail, those skilled in the art could readily devise many other varied embodiments or mechanisms to incorporate these techniques. Also, embodiments can include various operations as set forth above, fewer operations, or more operations; or operations in another order than that specifically described above. Additionally, any of the components and steps described herein may be combined with one another in any logical manner except where such components or steps would be exclusive to one another. Accordingly, the scope and spirit of the invention should be judged in terms of the claims, which follow as well as the legal equivalents thereof.

1. A robotic kitchen system for carrying out a food preparation step within a robotic workspace, the system comprises:
a robotic arm;
a camera assembly for obtaining image data of the robotic workspace;
a utensil adapter assembly removably mounted to a utensil comprising a CV marker mount and at least one retro-reflective marker thereon;
a computer programmed and operable to detect and compute the location of the utensil based on the image data of the at least one retro-reflective marker; and
a robotic arm adapter having a proximal end coupled to the robotic arm and a distal portion adapted to releasably engage the utensil adapter assembly.

2. The robotic kitchen assistant of claim 1, wherein the robotic arm adapter comprises opposing movable gripping members having a first open configuration when the gripping members are separated, and a second closed configuration when the gripping members are urged towards one another to engage a target feature of the utensil adapter assembly.

3. The robotic kitchen assistant of claim 2, wherein the utensil is a fryer basket, and the utensil adapter assembly is secured to a handle portion of the fryer basket.

4. The robotic kitchen assistant of claim 3, wherein the target feature of the utensil adapter assembly comprises a three-dimensional shape selected from the group consisting of a diamond, sphere, hourglass, and bulb.

5. The robotic kitchen assistant of claim 2, wherein the computer is further operable to instruct the robotic arm and gripper assembly to: move the gripper assembly to the target feature; grasp the target feature; move the utensil; and release the utensil.

6. The robotic kitchen assistant of claim 1, wherein the camera assembly comprises at least one IR emitter, and optionally more than 5 IR emitters.

7. The robotic kitchen assistant of claim 6, further comprising a bandpass filter selected to allow only the light in the near IR wavelength range to pass therethrough.

8. The robotic kitchen assistant of claim 6, wherein the wavelength of the IR emitter ranges from 900-980 nm, and optionally is about 940 nm.

9. The robotic kitchen assistant of claim 1, wherein the camera exposure settings are controlled to reduce the light received and optionally, to reduce the shutter speed to 300-600 microseconds below the normal auto exposure setting.

10. The robotic kitchen assistant of claim 1, wherein the at least one retro-reflective marker comprises a plurality of retro-reflective markers, at least one at a different angle to another.

11. The robotic kitchen assistant of claim 1, wherein the mount is spaced above and over the basket.

12. The robotic kitchen assistant of claim 11, wherein a portion of the mount is parallel to the base/floor of the basket.

13. A robotic kitchen system for carrying out a food preparation step within a robotic workspace, the system comprises:
at least one retro-reflective marker arranged on an object in the kitchen workspace;
a camera assembly comprising a light emitter and aimed at a scene containing the at least one retro-reflective marker, said camera assembly generating image data of the scene including the at least one retro-reflective marker; and
a computer programmed and operable to identify and locate the at least one retro-reflective marker based on the image data.

14. The system of claim 13, wherein the emitter is an IR emitter.

15. The system of claim 13, wherein the object is selected from a kitchen appliance and kitchen utensil, and optionally, the object is one of a fryer and fryer basket.

16. A method for carrying out a food preparation step within a robotic kitchen workspace, the method comprising:
installing a retro-reflective marker on an object in the robotic kitchen workspace;
arranging at least one IR light source adjacent a lens of a camera;
directing IR light from the light source at a scene containing the retro-reflective marker;
receiving, by the lens, light reflected off the marker and the surroundings;
generating image data of the scene including the marker; and
detecting the identity and location of the marker based on the image data.

17. The method of claim 16, further comprising filtering the light by wavelength prior to the generating step.

18. The method of claim 17, further comprising reducing the amount of light by exposure settings prior to the generating step.

19. The method of claim 16, wherein the installing comprises installing multiple retro-reflective markers, at least one at a different angle to the another.

20. The robotic kitchen assistant of claim 1, wherein the retro-reflective marker comprises a composite graphical image comprising first elements having retro-reflective properties and second elements having non-retro reflective properties, and optionally, wherein the first elements are white and the second elements are black.
